(19) United States
(12) Patent Application Publication
(10) Pub. No.: US 2024/0253953 A1
(43) Pub. Date: Aug. 1, 2024

(54) Device for Lifting and Stabilizing Loads

(71) Applicant: Siemens Aktiengesellschaft, Muenchen (DE)

(72) Inventors: Andreas SCHWANK, Kelsterbach (DE); Eric SOTER, Hanau (DE)

(21) Appl. No.: 18/561,799

(22) PCT Filed: Apr. 20, 2022
(86) PCT No.: PCT/EP2022/060397

§ 371 Date: Nov. 17, 2023

(30) Foreign Application Priority Data
May 21, 2021 (EP) 21175255.5

(51) Int. Cl. B66C 13/06; B62D 65/18

(52) U.S. Cl. CPC B66C 13/06; B62D 65/18

(57) ABSTRACT

A device for lifting and stabilizing loads, particularly hangers for vehicles or vehicle parts, includes a frame and a crossbeam that is disposed below the frame and that receives the load, wherein the crossbeam is height-adjustable via lifting elements fastened to the crossmember and stabilizable via at least one telescopic strut that extends diagonally substantially in an imaginary vertical plane parallel to the movement direction of the frame and that is pivotally connected, at one end, to the frame and, at the other end, to the crossmember, and the length of which telescopic strut is adjustable during lifting or lowering to avoid a lateral offset between the frame and the crossbeam, where the telescopic strut includes an actuator for actively changing the length of the telescopic strut, and a control unit is provided for adjusting the length of the telescopic strut at least during a lifting or lowering movement.

### CROSS-REFERENCE TO RELATED APPLICATIONS

This is a U.S. national stage of application No. PCT/EP2022/060397 filed 20 Apr. 2022. Priority is claimed on European Application No. 21175255.5 filed 21 May 2021, the content of which is incorporated herein by reference in its entirety.

### BACKGROUND OF THE INVENTION

### 1. Field of the Invention

The invention relates to a device for lifting and stabilizing loads, in particular hangers for vehicles or vehicle parts, consisting of a frame and, lying therebelow, a crossbeam which receives the load, is height-adjustable by lifting cables fastened to the crossbeam, and is stabilized by means of at least one telescopic strut.

### 2. Description of the Related Art

Devices for lifting and stabilizing loads are used above all in automotive assembling so as to transport vehicle parts or the vehicle to be assembled in its respective stage of assembly between the individual assembly stations. For this purpose, the frame is usually displaceable horizontally on a rail. Here, the crossbeam via the lifting cables articulated thereon, or other lifting elements (chains, belts or the like), is height-adjustable via hoists disposed on the frame.

The suspension of the load should be as stable as possible, particularly in the case of a vehicle provided for assembling, because many assembly procedures are performed fully automatically, where precise positioning of the support device is crucial, which in turn requires the load to be suspended so as to be as stable as possible on the crossbeam. Simple rope drives with vertical support cables are not suitable for reliably preventing the load from swaying in all directions to the same extent. Consequently, articulated arms or scissors are used in addition to the guying, which are articulated on the frame, on one side, and on the crossbeam, on the other side, and stabilize the load without impeding the lifting and lowering movements.

The numerous conventional solutions are complex, heavy and expensive. German patent application DE 36 36 459 A1 thus describes a generic device for guiding a load, which consists of a displaceable frame, on which a crossbeam is articulated so as to be height-adjustable, so to speak.

DE102018100776A1—Straube “Lifting system, suspended track having a lifting system, and production and/or assembly system having a suspended track” shows stabilization by telescopes which in the standby state can be blocked via braking elements.

DE 42 19 370 A1—Mende et al. “Lifting device for loads” discloses a lifting device which operates using a multiplicity of hydraulic cylinders and enables the load to be pivoted in a plurality of degrees of freedom.

Publication DE 10 2005 038 820 B4—Ezichas “Mobile lifting device” shows stabilization via a flexurally stiff, pivotably mounted strut, where the articulation point of the latter is displaceable via a linear drive.

DE 3636459 A1—Potocnjak “Device for guiding a load on a conveyor installation” shows, in a manner analogous to the solution of DE 10 2004 045 516 A1 mentioned hereunder, stabilization via tethers in telescopic struts.

In order to stabilize modules for lifting and lowering loads in conveyor systems (so-called hoists or “hangers”), telescopic struts (for short: telescopes) are often used. In the process, an internal tube, which is displaced in an external tube, is deployed or retracted during the lifting or lowering movement. In order to avoid swaying movements of the load in and counter to the direction of displacement of the frame, two such variable-length telescopic struts are provided so as to cross one another between the frame and the crossbeam here, which telescopic struts in their end regions are fastened in an articulated manner to the crossbeam on one side and to the frame on the other side and serve to absorb the forces that arise in the direction of travel of the support device.

The lifting of the load in this solution is performed by the lifting cables that are articulated in the corner regions of the crossbeam, and via deflection rollers in the corner regions of the frame are guided to a hoist disposed centrally on the frame. In order for the retracting and deploying movement of the telescopic struts to be synchronized, the telescopic struts are stabilized and synchronized via a cable system made from tethers.

Such arrangements using cable-based synchronization are disclosed in DE 10 2004 045 51 A1—ABmann “Device for lifting and stabilizing loads”, where a cable routing that synchronizes the movement of the telescopes is chosen such that lateral swaying movements are attenuated.

Disadvantages are derived from the described effect of the guying in the prior art discussed, for example, because constant twisting and untwisting of the steel cables that are usually used occur due to the cable routing via the pivot bearings of the telescopic struts, and thus lengthening of cables and wear occur. The issue of the construction thus results in an undesirable change in length of the telescopic struts owing to forces that act in the longitudinal direction of the crossbeam. The lengthening of the cables must be regularly compensated for by re-tensioning and regular adjustment. The same applies to landing procedures, slippage and other variations that may arise over time. Moreover, assembling, adjusting and servicing are not trivial and thus expensive and time-consuming.

### SUMMARY OF THE INVENTION

In view of the foregoing, it is therefore an object of the present invention to provide a structure for synchronizing the displacement of telescopic struts, which is simply constructed and which has a functionally, low-maintenance construction.

A core concept of the solution in accordance with the invention of this object lies in performing the bracing and stabilizing of the device (lifting device, hanger) with the aid of one or a plurality of active telescopic struts, e.g. telescopic spindles.

These and other objects and advantages are achieved in accordance with the invention by a device for lifting and stabilizing loads, in particular hangers for vehicles or vehicle parts, consisting of a frame and, disposed therebelow, a crossbeam that receives the load, is height-adjustable by lifting elements fastened to the crossbeam, and is stabilizable via at least one telescopic strut that extends diagonally substantially in an imaginary vertical plane parallel to the direction of displacement of the frame, and is pivotably articulated on the frame on one side and on the crossbeam on the other side, where the length of the telescopic strut is adaptable to avoid a lateral offset between the frame and the crossbeam during a lifting or lowering procedure. The telescopic strut herein comprises an actuator (preferably a servo drive) for actively changing the length, where a control installation is provided for adapting the length of the telescopic strut at least during a lifting or lowering movement. The device furthermore comprises a measuring installation for measuring a lateral offset of the crossbeam relative to the frame, where the length of the at least one telescopic strut, when exceeding a predefined maximum lateral offset, is changed so as to counteract the offset. Owing to the fact that the telescopic strut is moved synchronously with the lifting motion, a stabilizing right-angled triangle is formed at all times so that transverse swaying is prevented and the lifted load is securely fixed thereto even during mechanical work.

The features described herein, and the advantages thereof, can be implemented individually as well as in meaningful combination with one another.

Greater stability is derived when two telescopic struts that cross one another and that are disposed so as to be diagonal in the imaginary vertical plane parallel to the direction of displacement of the frame are provided for stabilization. It is advantageously provided herein that the two telescopic struts are actuated such that their respective changes in length occur so as to be substantially synchronous with one another.

In one embodiment, which is easy to implement, the at least one telescopic strut comprises, as an actuator for actively changing the length, a mechanical actuation device that is driven via a motor, for example, a spindle or a worm drive. Such drives, which are also referred to as servo drive, are typically self-locking, so that an otherwise necessary brake for the stationary state can be dispensed with. Alternatively, hydraulic actuation devices, in particular hydraulic cylinders, can also be provided for implementing the telescopic strut(s). In the case of only one telescopic strut, a dual-action hydraulic cylinder must be used for this purpose.

The drive (actuator for actively changing the length) is advantageously formed as an electric stepper motor or as an electric linear drive, or comprises one of the latter. In many instances, a length-measuring installation (e.g., rotary encoder or linear encoder) in the telescopic strut can be dispensed with here. The stepper motor, or the linear drive, respectively, with each step displaces the telescopic strut by a defined distance (length) so that a corresponding sequence of steps can be actuated in a manner analogous to a lifting movement in order to maintain at right angles the geometry of the resulting stiffening triangle, or to avoid a lateral movement of the crossbeam relative to the frame. An embodiment with stepper motors is particularly expedient when two crossing telescopic struts are used, because the synchronous movement of the telescopic struts is automatically provided in a synchronous actuation of the stepper motors.

In accordance with disclosed embodiments of the invention, the device comprises a measuring installation for measuring a lateral offset of the crossbeam relative to the frame, where the length of the at least one telescopic strut, when exceeding a predefined maximum lateral offset, is changed so as to counteract the offset. Alternatively or additionally, a further measuring installation for continuously measuring the spacing between the frame and the crossbeam, or for detecting the distance and/or the speed of a lifting or lowering movement, respectively, can be provided, via which a controller can then compute the respectively required displacement path of the at least one telescopic strut, and can appropriately actuate the at least one telescopic strut. A length of the at least one telescopic strut respectively required for avoiding the lateral offset can thus be adjusted by way of a respective lifting height.

A control installation for actuating the change in length of the at least one telescopic strut is advantageously provided. In the case of only one telescopic strut being used, the telescopic strut in this instance is simply retracted or deployed accordingly as a function of the direction of the offset. For this purpose, a feedback-control algorithm can be used in particular in the case of high displacement speeds or precision requirements, for example, a PID controller. In the case of two telescopic struts that cross one another, a compressive and tensile load can be detected for each of the telescopic struts. In the simplest case, in the form of a compression spring at one of the articulation points, preferably at the lower crossbeam, where two (2) microswitches monitor the deflection of the spring and suffice for differentiating between the states compression (neutral) traction. Should both telescopic struts be stressed for compression when displacing the device, thus when lifting or lowering, then both telescopic struts are retracted gradually or continuously in a synchronized manner until at least one telescopic strut transitions to the neutral or the traction state. In most instances, the compressive stress on both sides naturally occurs when lifting the hanger, or similar. The controlled readjustment enables the telescopic struts to automatically adapt to the lifting procedure without any loss in terms of their stabilizing effect. Conversely, and this state will in most instances arise in a lowering movement, in the case of a simultaneous tensile stress, both telescopic struts are deployed synchronously until at least one of the telescopic struts is no longer subjected to tensile stress.

It should be understood that the embodiment having in each case two (2) microswitches per measuring installation can only be used for binary feedback-control and is therefore associated with corresponding disadvantages (jolting operation mode, no adaptation of the speed, etc.). Analog pressure transducers, for example, based on semiconductors, with strain gauges or by means of FBG (fiber Bragg grating), permit the use of highly dynamic feedback-control algorithms for the displacement of the telescopic struts.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of a telescopic strut according to the invention will be explained hereunder by way of the drawings, in which:

FIG. 1 shows a lateral view (sectional drawing) of the lowered device in accordance with the invention; and

FIG. 2 shows the inventive device in the retracted (lifted) state.

### DETAILED DESCRIPTION OF THE EXEMPLARY EMBODIMENTS

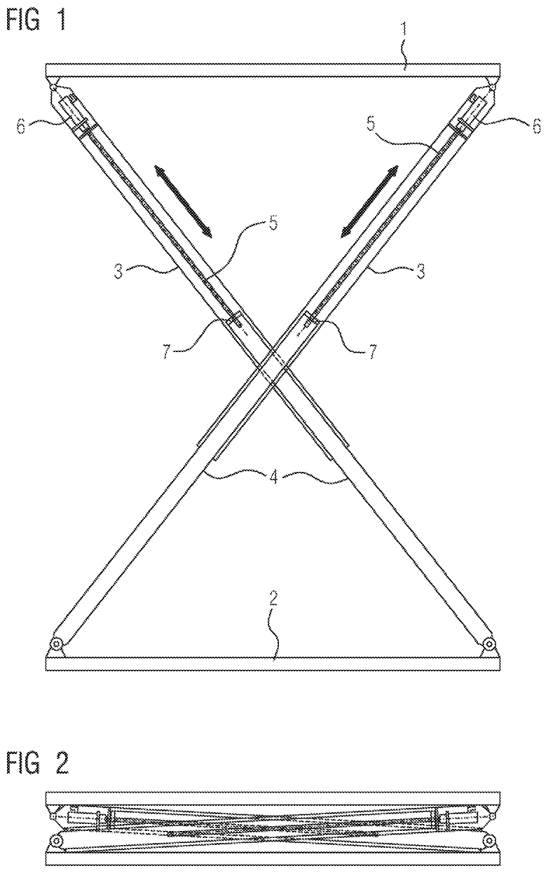

FIG. 1 shows an arrangement (hoist) in which cables or belts (not shown in FIG. 1) are used as lifting elements between the upper frame 1 and the crossbeam 2 (“lower frame”). Transverse movements (swaying) of the lower crossbeam 2 must be prevented particularly in the lowered state. To this end, FIG. 1 shows bracing and stabilizing of telescopic struts that are disposed in a cruciform manner between the upper frame 1 and the crossbeam 2. In a simple embodiment, one of the two active telescopic struts shown (e.g., telescopic spindle, dual-action hydraulic cylinder, or similar), which in a lowered state of the device extends substantially diagonally, suffices.

The fundamental concept of the invention is based on bracing and stabilizing of the telescopic struts with the aid of 2 threaded spindles 5.

An embodiment having 2 telescopic struts in a mutually crossing arrangement is illustrated in FIG. 1. In principle, however, the arrangement also functions with only one telescopic strut. FIG. 1 herein shows two threaded spindles 5 which, for actively changing the length 6, are each driven by one actuator (e.g., gear motor or stepper motor), hereunder referred to as servo drive. The servo drives 6 are synchronized with the lifting drive. The position of the threaded spindles 5 always tracks the corresponding lift. The threaded spindles 5 each connect the external tube 3 to the internal tube 4 in a form-fitting manner.

The spindle nut 7 is fastened to the end of the internal tube 4. A synchronous motor 6 is in each case fastened to the upper end of the external tube 3 and connected to the threaded spindle 5. The internal tube 4 is displaced relative to the external tube 3 by a rotational movement of the threaded spindle 5.

FIG. 2 shows the same arrangement in a “retracted” state, i.e., the crossbeam is displaced to a maximum height, and the telescopic struts are retracted to the maximum. For reasons of clarity, the lifting cables are not illustrated in the two figures.

Owing to the fact that the telescopic struts (for short: telescopes) are moved in a synchronous manner with the lift, a stabilizing triangle is at all times formed between the crossbeam 2, the telescopic strut 3, 4, and the lifting cable (not illustrated), and/or the frame 1, the telescopic strut 3, 4, and the lifting cable (not illustrated).

Stabilization using only one telescope 3, 4 and servo drive 6 is also possible.

In one advantageous embodiment, guidance of the internal tube in the external tube of the telescopic strut is performed by sliding blocks, which are easy to produce, instead of the roller bearings or ball bearings that are otherwise often customary. For easy assembly, these sliding blocks are inserted from the outside into corresponding openings in the external tube and guide the internal tube. They are preferably produced from a material with positive sliding properties, e.g., plastics material. This embodiment is low-maintenance. Owing to the assembly from the outside, a readjustment is easily possible (for example, by replacing spacers between the external tube and a contact face of the sliding blocks/sliding pieces), or a replacement of the sliding blocks. In addition, this results in play-free and quiet running.

As a result of the above-described construction and the disclosed embodiments thereof, with the aid of a suitable actuation, both internal tubes 3 are displaced synchronously when the telescopic struts are retracted as well as deployed. This prevents an undesirable change in length of the telescopic struts as a consequence of forces acting in the longitudinal direction of the crossbeam. The construction is self-stabilizing, and back and forth swaying of the lower crossbeam, in particular in the lowered state, is minimized or prevented.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A device for lifting and stabilizing loads, the device comprising:
a frame; and
a crossbeam disposed below the frame, said crossbeam receiving the load and being height-adjustable by a lifting elements fastened to the crossbeam, and being stabilized via at least one telescopic strut which extends diagonally substantially in an imaginary vertical plane parallel to the direction of displacement of the frame and being pivotably articulated on the frame on one side and on the crossbeam on the other side, a length of said at least one telescopic strut being adaptable to avoid a lateral offset between the frame and the crossbeam during a lifting or lowering procedure, and the telescopic strut including an actuator for actively changing the length; and
a control installation for adapting the length of the telescopic strut at least during a lifting or lowering movement; and
a measuring installation for measuring a lateral offset of the crossbeam relative to the frame;
wherein a length of the at least one telescopic strut, when exceeding a predefined maximum lateral offset, is changed so as to counteract the offset.

11. The device as claimed in claim 10, wherein the device includes two telescopic struts for stabilization, said two telescopic struts crossing one another and being disposed diagonally in the imaginary vertical plane parallel to the direction of displacement of the frame.

12. The device as claimed in claim 11, wherein the two telescopic struts are actuated such that their respective changes in length occur substantially synchronous with one another.

13. The device as claimed in claim 10, wherein the at least one telescopic strut comprises a mechanical actuation device which is driven via a motor.

14. The device as claimed in claim 13, wherein the mechanical actuation device comprises a spindle or a worm drive.

15. The device as claimed in claim 13, wherein the motor is a stepper motor.

16. The device as claimed in claim 14, wherein the motor is a stepper motor.

17. The device as claimed in claim 10, wherein a length of the at least one telescopic strut, which is respectively required for avoiding the lateral offset, is adjusted via a respective lifting height.

18. The device as claimed in claim 17, wherein the device comprises an installation for detecting a respective lifting height of the device.

19. The device as claimed in claim 10, wherein the at least one telescopic strut comprises an installation for detecting the respective length of said telescopic strut.

20. The device as claimed in claim 10, wherein the loads comprise hangers for vehicles or vehicle parts.
